(19) United States
(12) Patent Application Publication
(10) Pub. No.: US 2007/0105705 A1
(43) Pub. Date: May 10, 2007

(54) Porous ceramic and method for manufacturing the same

(75) Inventors: Michiko Fukuda, Tokyo (JP); Akiko Fukuda, Tokyo (JP)

Correspondence Address: DANIEL B. SCHEIN, PH.D., ESQ., INC., P. O. BOX 68128, Virginia Beach, VA, 23471, US

(73) Assignee: ENTEC CO., LTD.

(21) Appl. No.: 11/493,207

(22) Filed: Jul. 25, 2006

(30) Foreign Application Priority Data
Nov. 7, 2005 (JP) 2005-322779

(51) Int. Cl. C04B 38/00; C04B 33/36

(52) U.S. Cl. 501/80; 501/155; 264/629

(57) ABSTRACT

Porous ceramic having a homogenous pore structure in which pores having radii in a narrow range of 300 to 4000 nm occupy 90% or more of the total pore capacity. The porous ceramic is manufactured by a method including a first step of drying an initial composition containing waste as a main component, an aggregate and a binder. A second step mixes the components of the initial composition dried in the first step. A third step adds water to the mixture obtained in the second step. A fourth step performs extrusion molding with the water-added mixture obtained in the third step. A fifth step fires an intermediate molding product obtained in the fourth step.

### BACKGROUND OF THE INVENTION

The present invention relates to a porous ceramic manufactured using waste as a main component and useful as materials of, for example, pavements for roads, brick blocks and tiles for exterior walls, and ceramic aggregates. The present invention also relates to a method for manufacturing such a porous ceramic.

The processing of rapidly increasing industrial waste and waste incineration ash has become a major social issue. There is an urgent need to promote recycling of industrial waste and waste incineration ash. Various studies have been conducted to develop porous ceramic produced by recycling such industrial waste and waste incineration ash. The following is known as such a type of porous ceramic (for example, refer to Japanese Laid-Open Patent Publication No. 2004-217495). The porous ceramic described in this patent publication is manufactured by a method including a first step in which water is added to and mixed with an initial composition composed of powder (waste) containing 50% by mass or more of a compound of silicon (Si), aluminum (Al), and calcium (Ca), an aggregate that is fire resistant at 1000° C. or higher, and a binder. In a second step, the mixture obtained in the first step is molded into an intermediate molding product having a predetermined shape. In a third step, the intermediate molding product obtained in the second step is fired at a predetermined temperature. The amount of water added in the first step is 20 to 30% by mass relative to the mass of the mixture.

Specific examples of the powder (waste) include non-fired powder of sludge deposited in rivers or water purification plants and fired powder of various types of incinerated ash, ceramic waste clay, and volcanic ash. Specific examples of the aggregate that is fire resistant at 1000° C. or higher include chamotte obtained by crushing earthenware such as roof tile waste, grindstone debris, blast furnace slag, molten slag, and igneous rocks. Specific examples of the binder include various types of clay and sodium silicate. The porous ceramic has irregularly continuous pores having radii of several micrometers to one millimeter.

When used as a material for a road pavement, the porous ceramic is required to have various functions such as absorbing water from rainfall, holding the water internally, and controlling the increase of road surface temperature with the vaporization heat of the held water. In other words, the porous ceramic must have a superior water absorption capability and superior water holding capability.

However, it is difficult to ensure sufficient water absorption capability and water holding capability with the prior art porous ceramic described above. Since the prior art porous ceramic has pores of which radii is in an extremely widely range of several micrometers to one millimeter, and it is believed that there are many pores having excessively large radii (for example, about one millimeter). This results in the absorbed water passing through the pores.

Accordingly, it is an object of the invention to provide a porous ceramic having improved water absorption capability and water holding capability and a manufacturing method for such porous ceramic.

### SUMMARY OF THE INVENTION

To achieve the above object, one aspect of the present invention is a porous ceramic including a plurality of pores. The pores have a pore radius distribution in which pores with radii of 300 to 4000 nm when measured by performing mercury intrusion porosimetry occupy 90% or more of the total pore capacity.

In the above porous ceramic, pores having pore radii of 300 to 4000 nm occupy 90% or more of the total pore volume. The range of the pore radii is notably narrower than the porous ceramic of the prior art (several micrometers to about one millimeter). The pores having radii in the range of 300 to 4000 nm ensure sufficient water absorption amount and functions to hold the absorbed water therein without temporarily absorbed water passing therethrough. Accordingly, the porous ceramic of the present invention formed by the plurality of pores acting in such a manner (90% or more of the total pore volume) ensures sufficient water absorption and water holding capabilities.

A further aspect of the present invention is a method for manufacturing a porous ceramic including drying an initial composition of waste, an aggregate, and a binder, mixing the initial composition after the drying without adding water, adding water to the mixture obtained in the mixing; extrusion molding the water-added mixture obtained in the adding to obtain an intermediate molding product, and firing the intermediate molding product obtained in the extrusion molding.

In the above method, an initial composition composed of the components of waste, an aggregate, and a binder are dried. Then, the components are mixed without adding water. That is, the components are dry-mixed into a uniform mixture. Accordingly, the present invention avoids the problem of the prior art employing the so-called wet-type mixing in which these components are mixed in a state in which a large amount of water is added to the initial composition thereby causing non-uniform mixing of the components and lowering the water absorption and water holding capabilities. That is, in the manufacturing method of the present invention, the components are uniformly mixed without aggregating during the mixing. This decreases the difference in the thermal contraction rate between the components during firing. As a result, the obtained porous ceramic having a plurality of pores (90% or more of the total pore volume) with a predetermined size optimally hold the temporarily absorbed water. Thus, the porous ceramic obtained through the manufacturing method of the present invention ensures improvement in the water absorption and water holding capabilities.

Other aspects and advantages of the present invention will become apparent from the following description, taken in conjunction with the accompanying drawings, illustrating by way of example the principles of the invention.

### BRIEF DESCRIPTION OF THE SEVERAL VIEWS OF THE DRAWING

The invention, together with objects and advantages thereof, may best be understood by reference to the following description of the presently preferred embodiments together with the accompanying drawings in which:

FIG. 1 is a graph illustrating pore distribution in a brick block of test example 1; and

FIG. 2 is a graph illustrating pore distribution in a brick block of comparative example 1.

### DETAILED DESCRIPTION OF THE PREFERRED EMBODIMENTS

A porous ceramic according to a preferred embodiment of the present invention will now be described.

The porous ceramic of the preferred embodiment is manufactured from an initial composition composed of waste, an aggregate, and a binder. The porous ceramic is used as a material for road pavements and a material for brick blocks and tiles that form exterior walls.

The waste is contained as a main component in the initial composition for the porous ceramic and forms many pores in the porous ceramic when thermally contracted through firing. The term “main component” as used herein shall refer to a component contained in the initial composition being greater than 50%. Specific examples of this type of waste include paper mill sludge, incinerated ash from wood waste or the like, sludge deposited in rivers and water purification plants, ceramic waste clay, and volcanic ash. These wastes may be used solely or in combination with one another.

The content of the waste in the initial composition is 50 to 70% by mass and preferably 50 to 60% by mass. If the content of the waste in the initial composition is less than 50% by mass, a sufficient number of pores cannot be formed in the porous ceramic. This would make it difficult to ensure the required water absorption capability and water holding capability. If the content of the waste in the initial composition exceeds 70% by mass, too many pores will be formed in the porous ceramic. This would decrease the strength of the porous ceramic.

The aggregate is contained so that the porous ceramic has the required strength and fire resistance. Specific examples of this type of aggregate include chamotte, potsherd powder, steel slag, incineration slag, crushed sedimentary rocks, crushed metamorphic rocks, and crushed igneous rocks. The chamotte may be, for example, roof tile chamotte obtained by crushing a defective roof tile product. The potsherd powder may be, for example, crushed tiles, roof tiles, glass, and sanitary ware. The steel slag may be, for example, slow-cooled slag, water granulated slag, converter slag, and electric furnace slag. The incineration slag may be, for example, sewage sludge molten slag, incineration slag of various types of waste, and sewage sludge incineration slag. The sedimentary rocks include psephite, arenite, lutite, and tuff. The metamorphic rocks include hornfels, phyllite, schist, gneiss, and marble. The igneous rocks include basalt, liparite, diorite, gabbro, porphyrite, diabase, pyroxene andesite, and dacite. Other aggregates may include fly ash, clinker ash, sewage incinerated ash, and crushed autoclaved lightweight concrete (ALC). These may be used solely or in combination with one another.

The content of the aggregate in the initial composition is 20 to 30% by mass, and preferably 25 to 30% by mass. If the aggregate content in the initial composition is less than 20% by mass, it would be difficult to ensure sufficient strength and fire resistance for the porous ceramic. If the aggregate content in the initial composition exceeds 30% by mass, the moldability of the initial composition would be lowered.

The binder is contained for binding the components in the initial composition. Specific examples of this type of binder include various clays such as kaolinite clay, montmorillonite clay, sericite clay, halloysite clay, pyrophyllite clay, and bentonite clay, resins such as ethylene-vinyl acetate copolymer (EVA), polyvinyl alcohol (PVA), epoxy resin, acrylic resin, phenolic resin, urea resin, and melamine resin. Other examples are various cements, sodium silicate, starch, and gluten.

The content of the binder in the initial composition is 5 to 30% by mass, and preferably from 20 to 30% by mass. If the content of the binder in the initial composition is less than 5% by mass, the components cannot be sufficiently bound. This would decrease the material density and increase the possibility in which the porous ceramic does not have sufficient strength. If the content of the binder in the initial composition exceeds 30% by mass, an improved effect cannot be expected for binding components. Therefore, such excessive use of the binder would be wasteful and not economical.

It is preferred that the initial composition further contain calcium oxide. Calcium oxide is contained for the purpose of increasing the alkaline strength (pH) of the porous ceramic to optimally prevent the propagation of moss and fungi on the surface thereof. The content of calcium oxide in the initial composition is 0.1 to 1.0% by mass, and preferably 0.4 to 1.0% by mass. If the content of calcium oxide in the initial composition is less than 0.1% by mass, the alkaline strength cannot be sufficiently increased, and the possibility of a lowered effect for preventing propagation of moss and fungi increases. If the content of calcium oxide in the initial composition exceeds 1.0% by mass, an improved effect cannot be expected. Thus, such excessive use of calcium oxide is wasteful and not economical.

In the preferred embodiment, the initial composition may further contain various additive agents such as a pigment, a foaming agent, and a firing aid. The pigment may be powder of iron oxide, titanium oxide, or cobalt oxide. The foaming agent may be a volatile organic solvent such as pentane, neopentane, hexane, isohexane, isoheptane, benzene, octane, or toluene. The firing aid may be a compound such as Y₂O₃, Yb₂O₃, Nd₂O₃, or CaO containing at least one of elements of group 2A (calcium (Ca), etc.) and elements of group 3A (yttrium (Y), neodymium (Nd), ytterbium (Yb), etc.) in the periodic law table.

Characteristics of the porous ceramic of the preferred embodiment will now be discussed in detail.

As described above, the porous ceramic of the preferred embodiment has many pores formed by thermal contraction of the waste contained in the initial composition. When measured by performing mercury intrusion porosimetry, pores with radii of 300 to 4000 nm occupy 90% or more of the total pore capacity. Thus, in the porous ceramic of the preferred embodiment, pores with radii of less than 300 nm and pores with radii exceeding 4000 nm occupy just less than 10% of the total pore capacity. If pores with radii of less than 300 nm occupy 10% or more of the total pore capacity, the pore capacity would decrease, and the amount of water entering the interior (pores) of the porous ceramic would also decrease. Thus, the possibility of both water absorption capability and water holding capability being lowered would decrease. If pores with radii of greater than 4000 nm occupy 10% or more of the total pore capacity, water absorbed in the interior (pores) of the porous ceramic would pass through the pores. This may lower the water holding capability.

The pore capacity of the porous ceramic measured by performing mercury intrusion porosimetry is preferably 0.1 to 0.15 mL/g. If the pore capacity is less than 0.1 mL/g, the low pore capacity would reduce the amount of water entering the pores. This may lower the water absorption capability and the water holding capability. If the pore capacity is greater than 0.15 mL/g, the strength of the porous ceramic may drastically be reduced. The area/weight ratio of the porous ceramic measured by performing mercury intrusion porosimetry is preferably 0.8 to 1.5 m²/g. If the area/weight ratio is lower than 0.8 m²/g, the strength of the porous ceramic may be drastically lowered. If the area/weight ratio is greater than 1.5 m²/g, the pore capacity decreases. This may reduce the amount of water entering the pores and lower the water absorption capability and the water holding capability.

The porous ceramic of the preferred embodiment is preferably alkaline from the viewpoint of inhibiting the propagation of moss and fungi on the ceramic surface and more preferably has a pH value of 10 or greater. The pH of the porous ceramic is obtained by immersing the porous ceramic in distilled water for 12 hours and then measuring the pH of the distilled water. The weight ratio of the porous ceramic to the distilled water is 1:1.

A method for manufacturing the porous ceramic of the preferred embodiment will now be described.

The porous ceramic of the preferred embodiment is manufactured by performing first to fifth steps. The first step is a step of drying the initial composition. The second step is a step of mixing the components of the initial composition subsequent to the first step without adding water. The third step is a step of adding water to the mixture obtained in the second step. The fourth step is a step of extrusion molding the water-added mixture obtained in the third step to obtain an intermediate molding product. The fifth step is a step of firing the intermediate molding product obtained in the fourth step. Each of these steps will now be described in detail.

In the first step, the initial composition is dried at a temperature of 100 to 400° C. to vaporize the moisture in the initial composition. If the drying temperature is lower than 100° C., more time would be required to dry the material and the production efficiency would be lowered. It may become difficult for the moisture in the initial composition to be sufficiently vaporized. If the drying temperature is higher than 400° C., a high effect can be expected with regard to the vaporization of moisture from the initial composition. However, the binder in the initial composition would be decomposed and the binding capability would be lost.

The moisture content of the initial composition in the first step is preferably 7% by mass or less. If the moisture content of the initial composition is greater than 7% by mass, it would become difficult to uniformly mix the initial composition components in the second step. This would lead to the formation of many pores having excessively large radii (for example, pores with radii greater than 4000 nm) or pores having excessively small radii (for example, pores with radii smaller than 300 nm). As a result, it will be difficult to ensure sufficient water absorption capability and water holding capability for the porous ceramic. The method of drying the initial composition is not particularly limited. The components of the initial composition subsequent to the first step are crushed into a predetermined uniform size.

In the second step, the components are uniformly mixed without adding water and bound together by the binder. The mixing of these components is performed by using a ball grinder, a Henscel mixer, a shaker, a tumbler, or a raikai mixer.

In the third step, water is added to the mixture obtained in the second step to obtain a water-added mixture. The amount of added water is preferably 20 to 30% by mass relative to the mass of the mixture. If the amount of added water is less than 20% by mass relative to the mass of the mixture, the flowability of the initial composition will be drastically lowered. This may lower the moldability in the fourth step. If the amount of added water is greater than 30% by mass relative to the mass of the mixture, the components of the mixture will be separated due to, for example, difference in particle size or specific gravity. This would make uniform mixing difficult. In addition, it will become difficult to increase the filling density in the fourth step.

In the fourth step, the water-added mixture obtained in the third step undergoes predetermined molding to obtain the intermediate molding product. The molding that is performed may be, for example, extrusion molding, press molding, doctor-blade method, cold isostatical pressing (CIP), or the like. However, vacuum extrusion molding is most preferable due to the easiness in increasing the compressive strength of the resulting porous ceramic. The extrusion pressure used for the vacuum extrusion molding is preferably 250 kg/cm² or greater from the viewpoint of increasing the filling density of the water-added material (molding material). The upper limit of the extrusion pressure depends on the type of molding machine that is used and is not particularly limited.

Preferably, in the present embodiment, the intermediate molding product is cured until the strength becomes sufficient. The curing method used herein is not particularly limited and includes, for example, atmospheric curing, water curing, and steam curing. The atmospheric curing is particularly preferable since it may be performed inexpensively. Curing conditions, such as temperature, humidity, and time, differ in accordance with the size of the intermediate molding product are thus not particularly limited.

In the fifth step, the intermediate molding product obtained in the fourth step is fired by using, for example, a continuous kiln. The continuous kiln that is used may be a rotary kiln, a roller house kiln, a tunnel kiln, or the like. The firing temperature is 1000 to 1200° C., and preferably 1100 to 1200° C. If the firing temperature is lower than 1000° C., there is a high possibility for the manufacturing of a porous ceramic having high strength becoming difficult. If the firing temperature is higher than 1200° C., vitrification will occur due to the excessively high firing temperature. The vitrification will cause the porous ceramic to contract and clog some of the pores. The firing time in the fifth step is not particularly limited as long as it is long enough for the entire intermediate molding product to reach the set firing temperature.

The operation of the porous ceramic of the preferred embodiment will now be discussed.

When manufacturing the porous ceramic of the present embodiment, as described above, the initial composition containing components such as waste, aggregate, and binder is dried in the first step. The components are then mixed in the second step. Thus, in the preferred embodiment, the components are dry-mixed in the second step in a state in which the content of water, which is the biggest factor in inhibiting uniform mixing, is minimized (at a moisture content of 7% by mass or less). This prevents the components from being aggregated and enables uniform mixing of the components. As a result, the difference in thermal contraction rate between the components is reduced during firing in the fifth step. This obtains a porous ceramic in which pores having radii in a predetermined range (300 to 4000 nm) occupy 90% or more of the total pore capacity.

The pores with radii in the range from 300 to 4000 nm not only ensure absorption of a sufficient amount of water but also hold the absorbed water without the water passing therethrough. Accordingly, the porous ceramic of the present invention, which includes many pores (90% or more of the total pore capacity), has sufficient water absorption capability and water holding capability. When such a porous ceramic is used, for example, as the material for road pavements, a sufficient amount of rainwater can be held for a long period of time. This would prevent an increase in the road surface temperature through vaporization of the rainwater held in the porous ceramic.

The porous ceramic (pavement material), which internally holds a sufficient amount of rainwater for a long period of time, has notable dampness. Thus, fungi and moss tends to easily propagate on the ceramic surface. Therefore, in the preferred embodiment, calcium oxide is preferably contained in the initial composition for the porous ceramic. When calcium oxide is contained, the alkaline level of the porous ceramic (pavement material) is increased. This inhibits the propagation of fungi or moss due to the interaction between the calcium oxide and fungi or moss.

The preferred embodiment has the advantages described below.

(1) In the porous ceramic of the present embodiment, pores having radii in a narrow range of 300 to 4000 nm occupy 90% or more of the total pore capacity. This improves the water absorption capability and water holding capability of the porous ceramic. When used, for example, as the material for road pavement, such porous ceramic holds rainwater for a long time. This suppresses increase in road surface temperature due to the vaporization of the rainwater held in the porous ceramic.

(2) The porous ceramic of the present embodiment has a pore capacity of 0.1 to 0.1.5 mL/g and an area/weight ratio of 0.8 to 1.5 m²/g when measured by performing mercury intrusion porosimetry. Accordingly, a sufficient amount of water may be held within the pores. This improves the water absorption capability and water holding capability of the porous ceramic.

(3) The porous ceramic of the present embodiment has a pH value of 10 or more, and thus has a high alkaline level. When used, for example, as the material for road pavements, the porous ceramic prevents propagation of fungi or moss in its surface and keeps the appearance of the pavement satisfactory.

(4) The porous ceramic of the present embodiment is manufactured by drying the initial composition containing components such as waste, an aggregate, and a binder in the first step, and then dry mixing the components in the second step. Accordingly, the preferred embodiment avoids the problems of the conventional manufacturing method employing wet mixing in which the components cannot be uniformly mixed and the water absorption capability and water holding capability of the porous ceramic are low. In other words, in the porous ceramic of the preferred embodiment, the components are uniformly mixed without being aggregated together. This decreases the difference in thermal contraction rate between the initial composition components during the firing in the fifth step. Thus, the porous ceramic has a many pores (90% or more of the total pore capacity) having predetermined sizes (radii in the range from 300 to 4000 nm) so as to enable the absorbed water to be optimally held. As a result, the water absorption capability and water holding capability of the porous ceramic are improved.

Further, the decreased difference in thermal contraction rate between components during the firing in the fifth step effectively prevents deformation and cracking of the porous ceramic during firing. Accordingly, in the preferred embodiment, a porous ceramic (material of, for example, pavements, blocks, brick blocks, and ceramic aggregates) improved in both dimensional accuracy and strength is obtained.

(5) The initial composition after the first step has a moisture content of 7% by mass or less. This facilitates uniform mixing of the components. Accordingly, a porous ceramic having a large number of pores of predetermined sizes (with radii in the range from 300 to 4000 nm) is easily obtained, and the porous ceramic has sufficient water absorption capability and water holding capability.

(6) The initial composition preferably contains calcium oxide. In such a case, the alkaline level (pH) of the porous ceramic containing calcium oxide is increased. Thus, the propagation of moss or fungi in the ceramic surface is optimally inhibited.

Further, the porous ceramic may be manufactured by the methods as described below. One method includes a first step for drying an initial composition, which is composed of waste, an aggregate, a binder, and calcium oxide. In a second step, the initial composition components dried in the first step are mixed. In a third step, water is added to the mixture obtained in the second step. In a fourth step, the water-added mixture obtained in the third step undergoes extrusion molding to obtain an intermediate molding product. In a fifth step, the intermediate molding product is fired. This method obtains a porous ceramic that easily inhibits propagation of moss and fungi.

Another manufacturing method includes a first step in which water is added to an initial composition composed of waste, an aggregate, a binder and calcium oxide and then mixing the components. In a second step, the mixture obtained in the first step undergoes extrusion molding to obtain an intermediate molding product. In a third step, the intermediate molding product is fired. In this method, a porous ceramic easily inhibiting propagation of moss and fungi is obtained.

The calcium oxide is contained in the initial composition preferably at a content of 0.1 to 1.0% by mass. In this case, the effect of the calcium oxide is fully exhibited, and the propagation of moss, fungi or the like is easily inhibited.

The embodiment will now be described in further detail through test examples and comparative examples.

Production of Brick Block

### TEST EXAMPLE 1

Initial composition composed of the components listed in table 1 was dried at 200° C. (first step), and the initial composition components were mixed with a mixer (second step). The moisture content of the initial composition subsequent to the first step was 5% by mass. Water was added to the mixture (third step), and the water-added mixture was subjected to vacuum extrusion molding to obtain an intermediate molding product (fourth step). The amount of water added to the mixture in the third step was about 23% by mass relative to the mass of the mixture. The intermediate molding product obtained in the fourth step was cured and then fired under predetermined conditions (at a firing temperature of 1100 to 1200° C. for a period of 48 hours) to produce a brick block having a rectangular parallelepiped shape of 200×100×60 mm. Physical properties of the brick block were evaluated as described below. The results are shown in table 1.

### COMPARATIVE EXAMPLE 1

Although the first step (the step of drying the initial composition) was omitted, the other steps in test example 1 were performed to produce a brick block in comparative example 1. More specifically, water was added to the initial composition composed of the components listed in table 1 and mixed together. The amount of water added to the initial composition was about 30% by mass relative to the mass of the initial composition. The mixture was subjected to vacuum extrusion molding to obtain an intermediate molding product. The intermediate molding product was cured and then fired under predetermined conditions (at a firing temperature of 1100 to 1200° C. for a period of 48 hours) to produce a brick block having a rectangular parallelepiped shape of 200×100×60 mm. Physical properties of the brick block were evaluated as described below. The results are shown in table 1.

Evaluation of Water Absorption Capability

The water absorption rate was measured in compliance with Japanese Industrial Standard (JIS) R 1250.

Evaluation of Water Holding Capability

The water holding capability was measured based on the following equation (1) in compliance with a quality standard for water-holding interlocking blocks. The measurement methods of “wet mass” and “absolute dry mass” in the equation (1) are as follows.
Water holding amount (g/cm³)=(wet mass (g)−absolute dry mass (g))/capacity of sample (cm³) (1)

The wet mass (g) was measured by a method in which each sample was immersed in water at 15 to 25° C. for 24 hours to absorb water. The sample was then taken out of the water and placed in an airtight container. The sample was left in a room at a temperature of 15 to 30° C. for 30 minutes to drain off water. After wiping off visually observable water from the sample with a rag, the mass of the sample was measured.

The absolute dry mass (g) was measured by a method in which each sample was placed in a dryer (at a temperature of 105° C.±5° C.) and dried until a predetermined mass was reached. The sample was then cooled to a normal temperature and the mass of the sample in this state was measured.

Evaluation of Strength

The bending strength was measured in compliance with Japanese Industrial Standard (JIS) A 5363.

Measurement of Pore Distribution

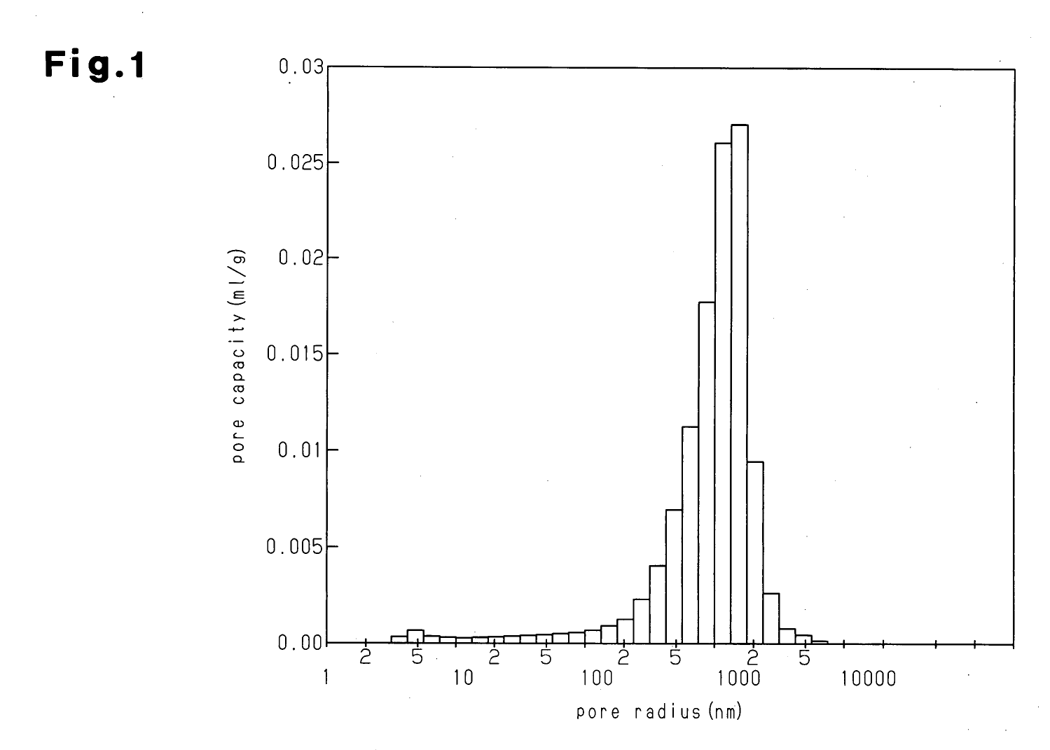

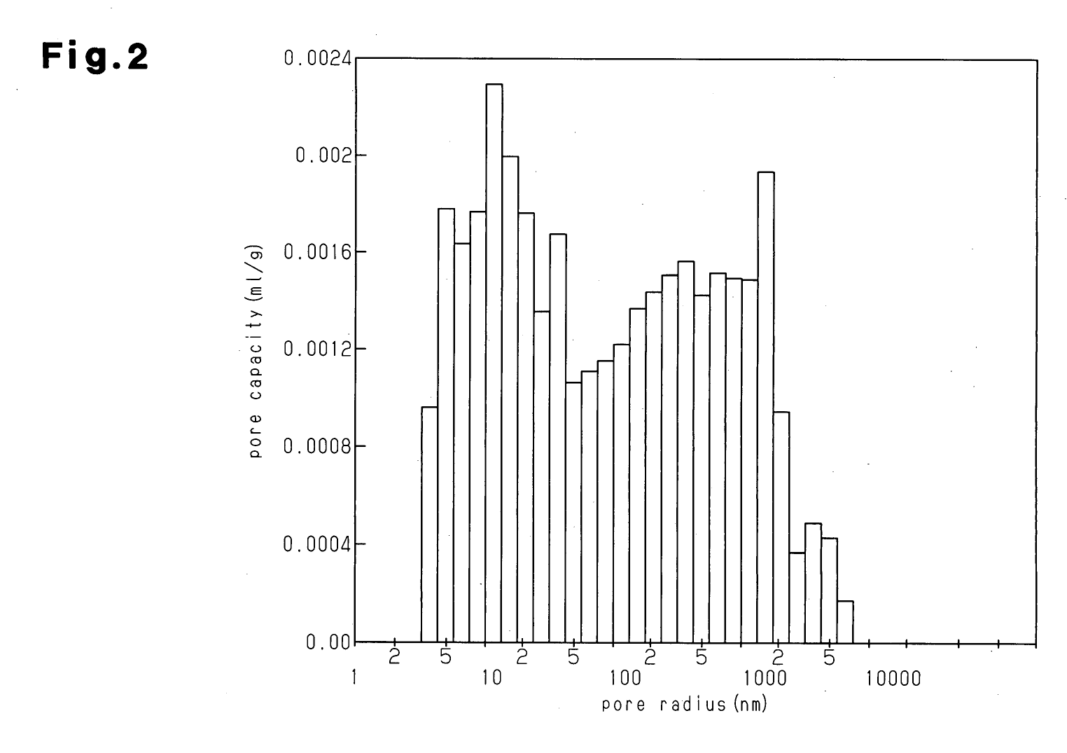

After drying each sample, pore radius distribution of the sample was measured by performing mercury intrusion porosimetry with a mercury porosimeter (Porosimeter Series 2000 manufactured by Carlo Erba Instruments). Further, the average pore radius (nm), the pore capacity (mL/g), and the area/weight ratio (m²/g) of the sample were found obtained from the pore radius distribution. FIG. 1 shows the pore radius distribution related to the brick block of test example 1, and FIG. 2 shows the pore radius distribution related to the brick block of comparative example 1.

TABLE 1

| | Test Example 1 | Comparative Example 1 |
|---|---|---|
| Paper Mill sludge | 50.0% by mass | 50.0% by mass |
| Incinerated Ash | | |
| (Waste) | | |
| Roof Tile Chamotte | 25.0% by mass | 25.0% by mass |
| (Aggregate) | | |
| Clay (Binder) | 24.3% by mass | 24.1% by mass |
| Pigment | 0.5% by mass | 0.5% by mass |
| Calcium Oxide | 0.2% by mass | 0.4% by mass |

(Evaluation)

| | | |
|---|---|---|
| Water Holding | 0.31 | 0.16 |
| Capability (g/cm³) | | |
| Water Absorption | 17.39 | 8.25 |
| Rate (%) | | |
| Bending Strength | 7.42 | 5.95 |
| (N/mm³) | | |
| Pore Capacity | 0.116 | 0.036 |
| (mL/g) | | |
| Area/Weight Ratio | 1.0 | 3.3 |
| (m²/g) | | |

As shown in table 1, it was found that the brick block of test example 1 exhibited notably increased pore capacity as compared with comparative example 1. As seen from FIGS. 1 and 2, the pore radius distribution of pores occupying a large part of the total pore capacity is much narrower in the brick block of test example 1 than in that of comparative example 1. It was also found that the brick block of test example 1 had a pore structure in which pores with radii of 300 to 4000 nm occupied 90% or more of the total pore capacity. It may be concluded from these results that both the water absorption capability (amount of water absorption) and the water holding capability (amount of held water) had been increased in the brick block of test example 1. The water holding capability, in particular, was remarkably high and two times greater than the standard value of 0.15 g/cm³, which is specified in the quality standard for water-holding interlocking blocks. It is believed that these favorable results were obtained for test example 1 because components such as waste, aggregate, and binder were mixed uniformly due to dry mixing thereby forming many pores (90% or more of the total pore capacity) having predetermined sizes (radii of 300 to 4000 nm) enabling optimal holding of the absorbed water.

In contrast, it was found for the brick block of comparative example 1 that, as seen from FIG. 2, the radius distribution of pores occupying a large part of the total pore capacity (90% or more) extended over a wide range (from 4 to 4000 nm). More specifically, the brick block of comparative example 1 had a large number of pores (for example, 60% or more of the total pore capacity) with extremely small radii (pores with radii smaller than 300 nm), and thus the pore capacity was drastically decreased. It is believed that, in comparative example 1, the amount of water entering the porous ceramic (pores) decreased and thus lowered both the water absorption capability (amount of absorbed water) and the water holding capability (amount of held water).

It was also found that the brick block of test example 1 had a higher bending strength as compared with that of comparative example 1. More specifically, it is apparent that the bending strength of the brick block of test example 1 had a notably high value that was about 1.5 times greater than the standard value of 5.0 N/mm² specified in the quality standard for water-holding interlocking blocks. This is believed due to the fact that the uniform mixing of the components reduced the difference in thermal contraction rate between components during firing and thus inhibited the generation of cracks.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

1. A porous ceramic comprising:
a plurality of pores, wherein the pores have a pore radius distribution in which pores with radii of 300 to 4000 nm when measured by performing mercury intrusion porosimetry occupy 90% or more of the total pore capacity.

2. The porous ceramic according to claim 1, wherein the pores have a pore capacity of 0.1 to 0.15 mL/g and an area/weight ratio of 0.8 to 1.5 m²/g when measured by performing mercury intrusion porosimetry.

3. The porous ceramic according to claim 1 having a pH value of 10 or greater.

4. A method for manufacturing a porous ceramic comprising:
drying an initial composition of waste, an aggregate, and a binder;
mixing the initial composition after said drying without adding water;
adding water to the mixture obtained in said mixing;
extrusion molding the water-added mixture obtained in said adding to obtain an intermediate molding product; and
firing the intermediate molding product obtained in the extrusion molding.

5. The method of manufacturing porous ceramic according to claim 4, wherein the initial composition is dried in said drying to a moisture content of 7% by mass or less.

6. The method of manufacturing porous ceramic according to claim 4, wherein the initial composition contains calcium oxide.
